(19) United States
(12) Patent Application Publication
(10) Pub. No.: US 2016/0154449 A1
(43) Pub. Date: Jun. 2, 2016

(54) SYSTEM ON CHIPS FOR CONTROLLING POWER USING WORKLOADS, METHODS OF OPERATING THE SAME, AND COMPUTING DEVICES INCLUDING THE SAME

(71) Applicants: Eui Choel LIM, Hwaseong-si (KR); Chang Hoon OH, Seoul (KR); Dong Hee HAN, Hwaseong-si (KR)

(72) Inventors: Eui Choel LIM, Hwaseong-si (KR); Chang Hoon OH, Seoul (KR); Dong Hee HAN, Hwaseong-si (KR)

(21) Appl. No.: 14/943,268

(22) Filed: Nov. 17, 2015

(30) Foreign Application Priority Data
Nov. 27, 2014 (KR) 10-2014-0167104
Oct. 15, 2015 (KR) 10-2015-0144046

(51) Int. Cl. G06F 1/32

(52) U.S. Cl. CPC G06F 1/324

(57) ABSTRACT

A system on chip may include: a master device configured to execute a dynamic voltage and frequency scaling (DVFS) program; a slave device configured to communicate with the master device; and/or a performance monitoring unit configured to receive first events generated while instructions are being processed by the master device, configured to generate a first count value by counting a number of second events corresponding to a total number of the instructions related with the first events and configured to generated a second count value counting a number of third events related with first instructions that can be processed by interaction between the master device and the slave device among the first events. The DVFS program may be configured to generate a control signal for controlling DVFS of at least one of the master device and the slave device based on the first count value and the second count value.

### CROSS-REFERENCE TO RELATED APPLICATIONS

This application claims priority under 35 U.S.C. §119 to Korean Patent Application Nos. 10-2014-0167104, filed Nov. 27, 2014, and 10-2015-0144046, filed Oct. 15, 2015, in the Korean Intellectual Property Office (KIPO), the entire contents of which are incorporated herein by reference.

### BACKGROUND

1. Field

Some example embodiments of the inventive concepts may relate generally to system on chip (SoC). Some example embodiments of the inventive concepts may relate generally to SoCs for controlling dynamic voltage and frequency scaling (DVFS) according to types of workloads of a master and controlling DVFS of a slave that communicates with the master. Some example embodiments of the inventive concepts may relate generally to methods of operating the SoCs. Some example embodiments of the inventive concepts may relate generally to computing devices including the SoCs.

2. Description of Related Art

Conventionally, DVFS may be performed in computing systems using information only about target devices of the DVFS. In DVFS of central processing units (CPU), the frequencies of clock signals applied to the CPUs and the levels of operating voltages may be increased when current loadings measured in the CPUs are higher than upper thresholds, and may be decreased when the current loadings are lower than lower thresholds.

In cases where the operating frequencies of CPUs communicating with memory systems are high while the operating frequencies of the memory systems are low, conventional DVFS methods may increase the operating frequencies and voltages of the CPUs when the workloads of the CPUs increase. However, when the workloads of the CPUs are memory-oriented workloads, the performance of the CPUs may not increase even though the operating frequencies and voltages of the CPUs increase, but only the power consumptions of the CPUs may increase.

### SUMMARY

Some example embodiments of the inventive concepts may provide SoCs for controlling DVFS according to types of workloads of masters.

Some example embodiments of the inventive concepts may provide SoCs for controlling DVFS of slaves that communicate with the masters.

Some example embodiments of the inventive concepts may provide methods of operating the SoCs.

Some example embodiments of the inventive concepts may provide computing devices including the SoCs.

In some example embodiments, a system on chip may comprise: a master device configured to execute a dynamic voltage and frequency scaling (DVFS) program; a slave device configured to communicate with the master device; and/or a performance monitoring unit configured to receive first events generated while instructions are being processed by the master device, configured to generate a first count value by counting a number of second events corresponding to a total number of the instructions related with the first events, and configured to generates a second count value by counting a number of third events related with first instructions that can be processed by interaction between the master device and the slave device from among the first events. The DVFS program may be configured to generate a control signal for controlling DVFS of at least one of the master device and the slave device based on the first count value and the second count value.

In some example embodiments, the master device may be one of a central processing unit (CPU), a graphics processing unit (GPU), an image signal processor (ISP), a digital signal processor (DSP), and a multimedia processor. The slave device may be one of a memory interface and an input/output interface.

In some example embodiments, the system on chip may further comprise: a clock management unit configured to control at least one of a first frequency of a first clock signal applied to the master device and a second frequency of a second clock signal applied to the slave device in response to the control signal.

In some example embodiments, the system on chip may further comprise: a power management unit configured to control a power management integrated circuit to control at least one of a level of a first voltage applied to the master device and a level of a second voltage applied to the slave device in response to the control signal.

In some example embodiments, the second events are related with instructions executed by the master device and the third events are related with L2 cache misses.

In some example embodiments, the DVFS program may be configured to calculate a misses-per-kilo-instructions (MPKI) value based on the first count value and the second count value, and/or may be configured to generate the control signal based on the MPKI value. The second count value may be an L2 cache miss count.

In some example embodiments, a computing device may comprise: a master device configured to execute a dynamic voltage and frequency scaling (DVFS) program; a slave device configured to communicate with the master device; a performance monitoring unit configured to receive first events generated while instructions are being processed by the master device, configured to generate a first count value by counting a number of second events corresponding to a total number of the instructions related with the first events, and configured to generate a second count value by counting a number of third events related with first instructions that can be processed by interaction between the master device and the slave device from among the first events; and/or a power management integrated circuit (PMIC) configured to provide a corresponding operating voltage to the master device, the slave device, and the performance monitoring unit. The DVFS program may be configured to generate a control signal for controlling DVFS of at least one of the master device and the slave device based on the first count value and the second count value.

In some example embodiments, the master device may be one of a central processing unit (CPU), a graphics processing unit (GPU), an image signal processor (ISP), a digital signal processor (DSP), and a multimedia processor. The slave device may be one of a memory interface and an input/output interface.

In some example embodiments, the computing device may further comprise: a clock management unit configured to control at least one of a first frequency of a first clock signal applied to the master device and a second frequency of a second clock signal applied to the slave device in response to the control signal.

In some example embodiments, the computing device may further comprise: a power management unit configured to control the PMIC to control at least one of a level of a first voltage applied to the master device and a level of a second voltage applied to the slave device in response to the control signal.

In some example embodiments, the second events are related with instructions executed by the master device and the third events are related with L2 cache misses.

In some example embodiments, the DVFS program may be configured to calculate a misses-per-kilo-instructions (MPKI) value based on the first count value and the second count value, and/or may be configured to generate the control signal based on the MPKI value. The second count value may result from counting L2 cache misses.

In some example embodiments, the computing device may further comprise: a memory. The master device may be one of a central processing unit (CPU), a graphics processing unit (GPU), an image signal processor (ISP), a digital signal processor (DSP), and a multimedia processor. The slave device may be a memory interface is configured to control operation of the memory according to control of the master device.

In some example embodiments, a method of operating a system on chip, which includes a master device executing a dynamic voltage and frequency scaling (DVFS) program and a slave device communicating with the master device, may comprise: receiving first events generated while instructions are being processed by the master device and generating a first count value corresponding to a number of the instructions among the first events; and/or the DVFS program controlling DVFS of the master device and DVFS of the slave device based on the first count value.

In some example embodiments, the master device may be one of a central processing unit (CPU), a graphics processing unit (GPU), an image signal processor (ISP), a digital signal processor (DSP), and a multimedia processor. The slave device may be one of a memory interface and an input/output interface.

In some example embodiments, the method may further comprise: generating a second count value by counting a number of second events related with first instructions that can be processed by interaction between the master device and the slave device among the first events. The DVFS program may be configured to control the DVFS of the master device and the DVFS of the slave device based on the first count value and the second count value.

In some example embodiments, the first count value may be cycles per instruction (CPI) value and the second count value is an L2 cache miss count.

In some example embodiments, the DVFS program may be configured to control the DVFS of the master device when the CPI value is less than a first reference value. The DVFS program may be configured to control the DVFS of the master device when the CPI value is greater than the first reference value and the L2 cache miss count is less than a second reference value.

In some example embodiments, the DVFS program may be configured to calculate a misses-per-kilo-instructions (MPKI) value based on the first count value and the second count value, and/or may be configured to control the DVFS of the master device and the DVFS of the slave device based on the MPKI value, wherein the first count value is a total number of the instructions, wherein the second count value is an L2 cache miss count.

In some example embodiments, the DVFS program may be configured to control the DVFS of the master device when the MPKI value is less than a first reference value, may be configured to control the DVFS of the slave device when the MPKI is greater than or equal to a second reference value, and/or may be configured to control the DVFS of the master device and the DVFS of the slave device when the MPKI value is greater than or equal to the first reference value and is less than the second reference value.

In some example embodiments, a computing device may comprise: a first device configured to execute a program; a second device configured to communicate with the first device; a third device configured to receive first events generated while instruction are being processed by the first device, configured to generate a first count value by counting a number of second events corresponding to a total number of the instructions related with the first events, and configured to generate a second count value by counting a number of third events related first instructions that can be processed by interaction between the first device and the second device from among the first events; and/or a fourth device configured to provide an operating voltage to the first device or the second device. The program may be configured to generate a control signal for controlling the first device, the slave, or the first device and the second device based on the first and second count values.

In some example embodiments, the program may comprise a dynamic voltage and frequency scaling (DVFS) program.

In some example embodiments, the program may be configured to control providing operating voltages to the first device and the second device.

In some example embodiments, the first device may comprise a central processing unit (CPU), a graphics processing unit (GPU), an image signal processor (ISP), a digital signal processor (DSP), or a multimedia processor.

In some example embodiments, the second device may comprise a memory interface or an input/output interface.

In some example embodiments, the computing device may further comprise: a fifth device configured to control a frequency provided to the first device or the second device.

In some example embodiments, the computing device may further comprise: a fifth device configured to control a level of the operating voltage provided to the first device or the second device.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a schematic block diagram of a computing device according to some example embodiments of the inventive concepts;

FIG. 2 is a diagram of a module included in a dynamic voltage and frequency scaling (DVFS) program executed by a master illustrated in FIG. 1;

FIG. 3 is a conceptual diagram of the interaction between a master and a slave;

FIG. 4 is a conceptual diagram of DVFS of at least one among a master and a slave according to a compute-bound or memory-bound workload;

FIG. 5 is a flowchart of DVFS of at least one among a master and a slave according to a workload of the master;

FIG. 6 is a conceptual diagram of a scheme of controlling DVFS of a master and DVFS of a slave;

FIG. 7 is a flowchart of a method of operating a system on chip (SoC) according to some example embodiments of the inventive concepts; and

FIG. 8 is a flowchart of a method of operating a SoC according to some example embodiments of the inventive concepts.

### DETAILED DESCRIPTION OF THE EMBODIMENTS

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature, their shapes are not intended to illustrate the actual shape of a region of a device, and their shapes are not intended to limit the scope of the example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

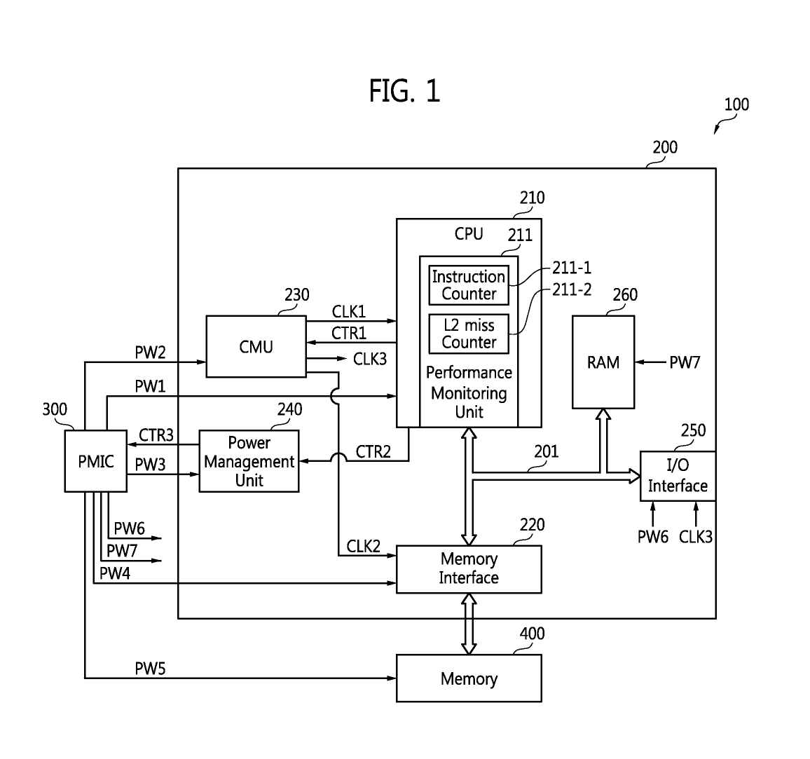

FIG. 1 is a schematic block diagram of a computing device 100 according to some example embodiments of the inventive concepts. The computing device 100 may include a controller 200, a power management integrated circuit (PMIC) 300, and a memory 400. The computing device 100 may be a personal computer (PC) or a mobile computing device. The mobile computing device may be a laptop computer, a cellular phone, a smart phone, a tablet PC, a personal digital assistant (PDA), an enterprise digital assistant (EDA), a digital still camera, a digital video camera, a portable multimedia player (PMP), a personal navigation device or portable navigation device (PND), a handheld game console, a mobile internet device (MID), a wearable computer, an internet of things (IoT) device, an internet of everything (IoE) device, or an e-book, but the inventive concepts are not restricted to these example embodiments.

The controller 200 may control the operation of the PMIC 300 and the operation of the memory 400. The controller 200 may be implemented as a host, an integrated circuit (IC), a mother board, a system on chip (SoC), an application processor (AP), a mobile AP, or a chipset. When the controller 200 is formed as a first package including a SoC, an AP, or a mobile AP, and the memory 400 is formed as a second package, the second package may be stacked over the first package. The controller 200 may include a bus architecture 201, a central processing unit (CPU) 210, a memory interface 220, a clock management unit (CMU) 230, a power management unit (PMU) 240, an input/output (I/O) interface 250, and an internal memory 260.

In some example embodiments of the inventive concepts, a master or a master device may be the CPU 210, a graphics processing unit (GPU), an image signal processor (ISP), a digital signal processor (DSP), a communication processor (CP), or a multimedia processor, but the inventive concepts are not restricted to these example embodiments. The CP may be a modem chip. In some example embodiments of the inventive concepts, a slave or a salve device may be the memory interface 220 or the I/O interface 250, but the inventive concepts are not restricted to these example embodiments.

A master may independently process at least some of instructions to be processed by itself during a given period of time and may process the rest of the instructions in association with a slave. The instructions may signify workloads. At least one master and at least one slave communicate signals and/or data with each other via the bus architecture 201.

It is assumed in some example embodiments of the inventive concepts that the CPU 210 is a master and the memory interface 220 or the I/O interface 250 is a slave, but the inventive concepts are not restricted to these example embodiments. A component operating as a master may operate as a slave, and vice versa, in some example embodiments.

The bus architecture 201 may be implemented as an advanced microcontroller bus architecture (AMBA®), an advanced high-performance bus (AHB), an advanced peripheral bus (APB), an advanced extensible interface (AXI), an advanced system bus (ASB), AXI Coherency Extensions (ACE), or a combination thereof, but the inventive concepts are not restricted to these example embodiments.

The CPU 210 may execute a dynamic voltage and frequency scaling (DVFS) program according to some example embodiments of the inventive concepts. A DVFS method controlled according to the DVFS program executed by a master (e.g., the CPU 210 may apply to the master and/or the slave which have been described above).

A performance monitoring unit 211 is implemented in hardware (e.g., a performance monitoring circuit) within the CPU 210. The performance monitoring unit 211 may measure or count performance parameters of the CPU 210. For instance, the performance monitoring unit 211 may measure or count parameters such as instruction cycles, cache hits, cache misses, and branch misses. For example, the performance monitoring unit 211 may measure or count the number of events related with a corresponding performance parameter from among the total number of events occurring during given time duration.

The performance monitoring unit 211 may receive all events (e.g., first events) generated while instructions (e.g., workloads) are being processed by the CPU 210 during the given time duration, generate a first count value by counting a number of events (e.g., second events) corresponding to the total number of the (executed) instructions from among the all events (e.g., first events), generate a second count value by counting a number of events (e.g., third events) related with instructions that can be processed by the interaction between the CPU 210 and the memory interface 220, and may output the first count value and the second count value. For example, the performance monitoring unit 211 may include a first counter 211-1 for generating the first count value and a second counter 211-2 for generating the second count value.

The DVFS program executed by the CPU 210 may calculate misses-per-kilo-instructions (MPKI) using the first count value and the second count value and may generate control signals for controlling DVFS of the CPU 210, of the memory interface 220, and of the I/O interface 250 according to the MPKI. At this time, the second count value may be an L2 cache miss count, which may indicate the number of L2 cache misses.

Alternatively, the performance monitoring unit 211 may generate a first count value related with CPI (cycles per instruction, clock cycles per instruction, or clocks per instruction) and/or a second count value corresponding to an L2 cache miss count. At this time, the DVFS program executed by the CPU 210 may generate control signals for controlling DVFS of the CPU 210, of the memory interface 220, and of the I/O interface 250 using the first count value and/or the second count value.

As well known, the CPI may be defined as equation:

$$CPI = \frac{CCI}{IC} ,$$

wherein CCI is the number of clock cycles for a given instruction type or the number of instructions for the given type, and IC is a total instruction count.

The memory interface 220, an example of a slave, may control a write operation or a read operation on the memory 400 according to the control of the CPU 210. The memory interface 220 may control the write or read operation on the memory 400 based on a second frequency of a second clock signal CLK2 output from the CMU 230 and the level of a fourth operating voltage PW4 output from the PMIC 300. Each of the second frequency of the second clock signal CLK2 and the level of the fourth operating voltage PW4 may be adjusted according to DVFS.

Although one memory interface 220 and one memory 400 are illustrated in FIG. 1 for convenience′ sake in the description, the memory interface 220 may be a memory interface set including a plurality of different memory interfaces, and the memory 400 may be a set including different memories. For instance, when the memory 400 is a set including dynamic random access memory (DRAM) and flash memory (e.g., NAND-type flash memory (logical NOT AND) or NOR-type flash memory (logical NOT OR)), the memory interface 220 may be a set including a DRAM controller and a flash memory controller, but the inventive concepts are not restricted to these example embodiments.

The memory 400 may be formed with volatile and/or non-volatile memory. The volatile memory may be random access memory (RAM), DRAM, static RAM (SRAM), thyristor RAM (T-RAM), zero capacitor RAM (Z-RAM), or twin transistor RAM (TTRAM), but the inventive concepts are not restricted to these example embodiments. The non-volatile memory may be electrically erasable programmable read-only memory (EEPROM), flash memory, magnetic RAM (MRAM), spin-transfer torque MRAM, ferroelectric RAM (FeRAM), phase-change RAM (PRAM), resistive RAM (RRAM), nanotube RRAM, polymer RAM (PoRAM), nano floating gate memory (NFGM), holographic memory, molecular electronics memory device, or insulator resistance change memory, but the inventive concepts are not restricted to these example embodiments.

The memory 400 may be implemented as a solid state drive or solid state disk (SSD), an embedded SSD (eSSD), a multimedia card (MMC), an embedded MMC (eMMC), or a universal flash storage (UFS), but the inventive concepts are not restricted to these example embodiments.

The CMU 230 may adjust a first frequency of a first clock signal CLK1 applied to the CPU 210, the second frequency of the second clock signal CLK2 applied to the memory interface 220, and/or a third frequency of a third clock signal CLK3 applied to the I/O interface 250 in response to a first control signal CTR1 output from the CPU 210 or from the DVFS program executed by the CPU 210. In some example embodiments, “to adjust” may mean to increase, to maintain, or to decrease.

The PMU 240 may generate a third control signal CTR3 for controlling an operation of the PMIC 300 in response to a second control signal CTR2 output from the CPU 210 or from the DVFS program executed by the CPU 210.

The PMIC 300 may adjust the level of each of the first through seventh operating voltages PW1 through PW7 in response to the third control signal CTR3. For instance, in response to the third control signal CTR3, the PMIC 300 may control the level of the first operating voltage PW1 applied to the CPU 210, the level of the second operating voltage PW2 applied to the CMU 230, the level of the third operating voltage PW3 applied to the PMU 240, the level of the fourth operating voltage PW4 applied to the memory interface 220, the level of the fifth operating voltage PW5 applied to the memory 400, the level of the sixth operating voltage PW6 applied to the I/O interface 250, and the level of the seventh operating voltage PW7 applied to the internal memory 260, but the inventive concepts are not restricted to these example embodiments.

Each of the first control signal CTR1, the second control signal CTR2, and the third control signal CTR3 may include at least one analog signal or at least one digital signal.

The I/O interface 250 is provided for input and output of data. The I/O interface 250 may transmit or receive data based on the third clock signal CLK3 output from the CMU 230 and the sixth operating voltage PW6 output from the PMIC 300. The third frequency of the third clock signal CLK3 and the level of the sixth operating voltage PW6 may be adjusted according to DVFS.

The I/O interface 250 may support serial advanced technology attachment (SATA), SATA express (SATAe), SAS (serial attached SCSI (small computer system interface)), peripheral component interconnect-express (PCIe®), non-volatile memory express (NVMe), or mobile industry processor interface (MIPI®), but the inventive concepts are not restricted to these example embodiments.

The internal memory 260 may be an operational memory of the CPU 210. For example, the internal memory 260 may be formed with read-only memory (ROM) or SRAM, but the inventive concepts are not restricted to these example embodiments. In cases where the memory 400 is formed with non-volatile memory, a DVFS program stored in the memory 400 may be loaded to the internal memory 260 and executed by the CPU 210 when the computing device 100 is booted.

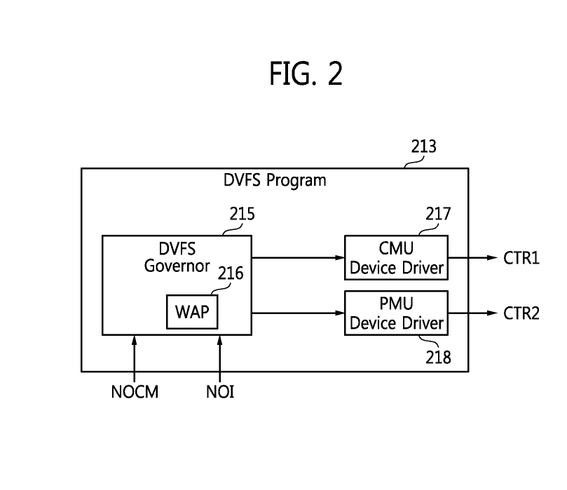

FIG. 2 is a diagram of a module included in a DVFS program 213 executed by the master illustrated in FIG. 1. Referring to FIGS. 1 and 2, the DVFS program 213 may include a DVFS governor 215, a CMU device driver 217, and a PMU device driver 218.

The DVFS governor 215, the CMU device driver 217, and the PMU device driver 218 may be modules. In some example embodiments, a module may be a computer program code or software that performs the function and operation corresponding to its name. The DVFS governor 215 may control the DVFS program 213 or the overall DVFS operation. The DVFS governor 215 may include a workload awareness program (WAP) 216. The execution of the WAP 216 may be controlled by the DVFS governor 215.

The WAP 216 may control the CMU device driver 217 and the PMU device driver 218 in response to a first count value NOI and/or a second count value NOCM. The first count value NOI and the second count value NOCM may be values having different information or data.

As described above, the first count value NOI may correspond to the number of the second events corresponding to the all executed (or committed) instructions among the first events generated instructions (e.g., workloads) are being processed by the CPU 210 during a given time or may be a value necessary to calculate a CPI value. The second count value NOCM may correspond to the number of third events related with instructions that can be processed by the interaction between the master (e.g., CPU 210) and the slave (e.g., memory interface 220 or I/O interface 250) among the first events generated while all instructions are being processed by the CPU 210 during the given time. For instance, the second count value NOCM may correspond to an L2 cache miss count, but is not restricted thereto

For example, the first events, second events, and the third events are will be described using PMU events used in ARM® Cortex®-A series processor.

TABLE 1

| | a counting operation at the generation of an |
|---|---|
| Event mnemonic | event (or event description) |
| SW_INCR | Count particular events in software |
| L1I_CACHE_REFILL | Count (or event related with) instruction |
| | memory accesses which triggers the refill of |
| | Level-1 instruction cache or unified cache |
| INST_RETIRED | Count (or event related with) instructions |
| | executed by a CPU |
| CPU_CYCLES | Count (or event related with) clock cycles |
| | of the CPU |
| MEM_ACCESS | Count (or event related with) the number of |
| | memory reads/writes |
| L2D_CACHE_REFILL | Count (or event related with) memory |
| | read/write accesses which triggers the refill of |
| | Level-2 data cache or unified cache and the |
| | refill of Level-1 instruction, data or |
| | unified cache |
| BUS_CYCLES | Count (or event related with) the number of |
| | cycles used in external memory interface |

The first events may refer to events having the same functions as or similar functions to all events, such as SW_INCR, L1I_CACHE_REFILL, INST_RETIRED, CPU_CYCLES, MEM_ACCESS, L2D_CACHE_REFILL, and BUS_CYCLES described in the table TABLE1, which are generated while the instructions are being processed. The second events may refer to events having the same functions as or similar functions to the event INST_RETIRED among the first events. The third events may refer to events having the same functions as or similar functions to the event L2D_CAHCE_REFILL among the first events.

The WAP 216 may calculate an MPKI value or a CPI value based on the first count value NOI and/or the second count value NOCM, and may transmit a first intermediate control signal to the CMU device driver 217 according to the calculation result. The CMU device driver 217 may output the first control signal CTR1 to the CMU 230 in response to the first intermediate control signal.

The WAP 216 may calculate an MPKI value or a CPI value based on the first count value NOI and/or the second count value NOCM, and may transmit a second intermediate control signal to the PMU device driver 218 according to the calculation result. The PMU device driver 218 may output the second control signal CTR2 to the PMU 240 in response to the second intermediate control signal.

The performance monitoring unit 211 may generate a third count value by counting a number of fourth events corresponding to the number of instructions that can be independently processed by the CPU 210 among first events generated while all instructions are being processed generated by the CPU 210 during the given time. The third count value may be provided for the WAP 216. At this time, the WAP 216 may calculate an MPKI value or a CPI value based on the first count value NOI, the second count value NOCM, and/or the third count value.

When the memory interface 220 is a slave, the second count value NOCM may correspond to memory-bound and the third count value may correspond to compute-bound. The term “compute-bound” may refer to core-bound, computing-bound, or CPU-bound.

The term “memory-bound” may refer to a situation in which the time to complete a task executed by the CPU 210 is decided by the access speed to the memory 400. However, compute-bound may refer to situation in which the time to complete a task executed by the CPU 210 is primarily decided by the speed of the CPU 210.

When the I/O interface 250 is a slave, the second count value NOCM may correspond to I/O-bound and the third count value may correspond to compute-bound. I/O-bound may refer to a situation in which the time to complete a task executed by the CPU 210 is decided by the speed to the I/O interface 250. For instance, when the first count value NOI is the sum of the second count value NOCM and the third count value, the WAP 216 may calculate the third count value using the first count value NOI and the second count value NOCM. The first count value NOI may correspond to workloads of a master (e.g., CPU 210).

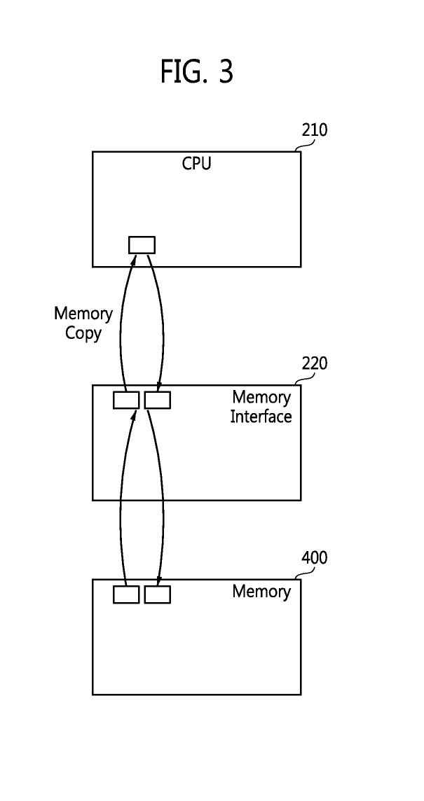

FIG. 3 is a conceptual diagram of the interaction between a master and a slave (e.g., memory-bound). The slave (e.g., memory interface 220) may store data output from the master (e.g., CPU 210) in the memory 400 during a write operation and may transmit data read from the memory 400 to the master during a read operation according to the control of the master.

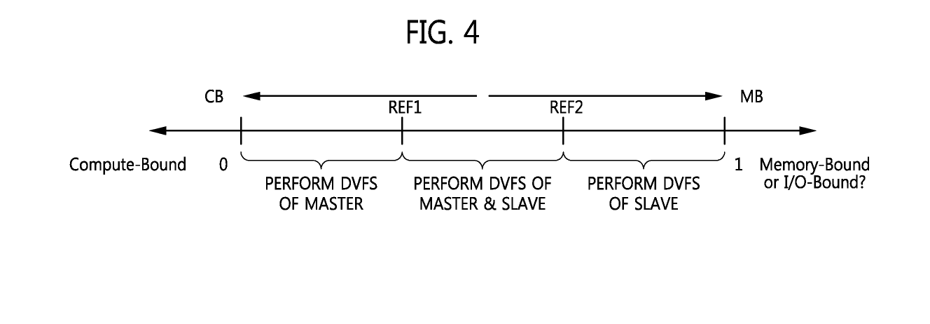

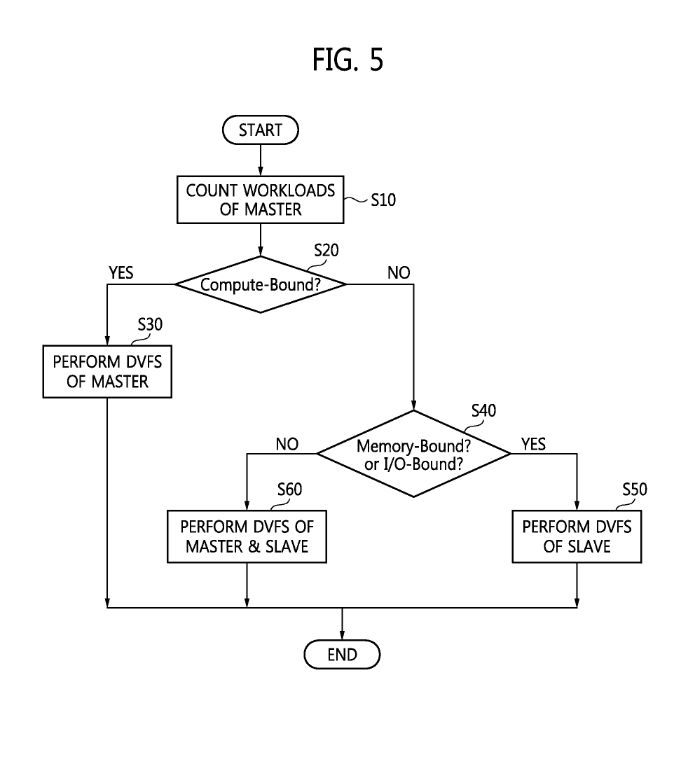

FIG. 4 is a conceptual diagram of DVFS of at least one among a master and a slave according to a compute-bound (“CB”) or memory-bound (“MB”) workload. FIG. 5 is a flowchart of DVFS of at least one among a master and a slave according to a workload of the master. The DVFS program 213 executed in the master (e.g., CPU 210) may detect whether current workloads of the CPU 210 are compute-bound or memory-bound (or I/O-bound) based on at least one of the first count value NOI and the second count value NOCM output from the performance monitoring unit 211 and may control DVFS of the master (e.g., CPU 210) and the slave (e.g., memory interface 220 or I/O interface 250) according to the detection result.

For instance, when the DVFS program 213 detects that the workloads of the CPU 210 are memory-bound or I/O-bound, the DVFS program 213 does not perform an operation of increasing a voltage and/or frequency for the CPU 210 even if the workloads of the CPU 210 are large or the loading of the CPU 210 is high, but the DVFS program 213 performs an operation of increasing a voltage and/or frequency for the slave (e.g., memory interface 220 or I/O interface 250). In other words, the DVFS program 213 performs an operation of increasing the voltage and/or frequency for the slave (e.g., memory interface 220 or I/O interface 250), and therefore, there can be an improvement in memory-oriented workload of the CPU 210.

However, when the DVFS program 213 detects that the workloads of the CPU 210 are memory-bound or I/O-bound and the workloads of the CPU 210 are large or the loading of the CPU 210 is high, a conventional DVFS program performs only an operation of increasing the voltage and/or frequency for the CPU 210, but does not perform an operation of increasing the voltage and/or frequency for the slave (e.g., memory interface 220 or I/O interface 250). At this time, although the voltage and/or frequency for the CPU 210 increases, the performance of the controller 200 including the CPU 210 and the slave (e.g., memory interface 220 or I/O interface 250) does not increase and the power consumption of the CPU 210 increases. Consequently, the power efficiency of the CPU 210 decreases.

The performance monitoring unit 211 may perform calculations on workloads based on first events, second events, and/or third events generated while instructions are being processed by the CPU 210, and may output at least one of the first count value NOI and the second count value NOCM corresponding to the calculation results to the WAP 216 of the DVFS program 213 in operation S10. The WAP 216 may calculate a CPI value or an MPKI value using at least one of the first count value NOI and the second count value NOCM. An MPKI value may refer to the second count value NOCM divided by the first count value NOI (e.g., NOCM/NOI). In other words, the second count value NOCM may refer to an L2 cache miss count and the first count value NOI may refer to the total number of instructions executed by the CPU 210 during a given time.

When the slave is the memory interface 220, the WAP 216 may detect whether the workloads of the CPU 210 are compute-bound or memory-bound based on the at least one of the first count value NOI and the second count value NOCM in operation S20. When it is detected that the workloads of the CPU 210 are compute-bound (in cases of YES) in operation S20, the WAP 216 may generate a first intermediate control signal and a second intermediate control signal so that DVFS of the CPU 210 is performed. The CMU device driver 217 may generate the first control signal CTR1 in response to the first intermediate control signal and the PMU device driver 218 may generate the second control signal CTR2 in response to the second intermediate control signal. The PMU 240 may generate the third control signal CTR3 based on the second control signal CTR2.

The CMU 230, operating in response to the first control signal CTR1, may increase the first frequency of the first clock signal CLK1 applied to the CPU 210. The PMIC 300, operating in response to the third control signal CTR3, may increase the level of the first operating voltage PW1 applied to the CPU 210. In other words, DVFS of the CPU 210 may be performed in operation S30.

However, when it is detected that the workloads of the CPU 210 are not compute-bound (in cases of NO) in operation S20, the WAP 216 may detect if the workloads of the CPU 210 are memory-bound in operation S40. When it is detected that the workloads of the CPU 210 are memory-bound (in cases of YES) in operation S40, the WAP 216 may generate a first intermediate control signal and a second intermediate control signal so that DVFS of the memory interface 220 is performed. In other words, even if the workloads of the CPU 210 are large, the WAP 216 may generate the first and second intermediate control signals so that the DVFS of the memory interface 220 instead of the CPU 210 is performed.

The CMU device driver 217 may generate the first control signal CTR1 in response to the first intermediate control signal, and the PMU device driver 218 may generate the second control signal CTR2 in response to the second intermediate control signal. The PMU 240 may generate the third control signal CTR3 based on the second control signal CTR2.

The CMU 230 operating in response to the first control signal CTR1 may increase the second frequency of the second clock signal CLK2 applied to the memory interface 220. The PMIC 300 operating in response to the third control signal CTR3 may increase the level of the fourth operating voltage PW4 applied to the memory interface 220. In other words, DVFS of the memory interface 220 may be performed in operation S50.

When it is detected that the workloads of the CPU 210 are neither compute-bound nor memory-bound (e.g., in cases of NO in both operations S20 and S40), the WAP 216 may generate a first intermediate control signal and a second intermediate control signal so that DVFS of the CPU 210 and DVFS of the memory interface 220 are performed simultaneously or in parallel.

The CMU device driver 217 may generate the first control signal CTR1 in response to the first intermediate control signal, and the PMU device driver 218 may generate the second control signal CTR2 in response to the second intermediate control signal. The PMU 240 may generate the third control signal CTR3 based on the second control signal CTR2.

The CMU 230 operating in response to the first control signal CTR1 may increase the first frequency of the first clock signal CLK1 applied to the CPU 210. The PMIC 300 operating in response to the third control signal CTR3 may increase the level of the first operating voltage PW1 applied to the CPU 210. In other words, DVFS of the CPU 210 may be performed in operation S60. Simultaneously or in parallel, the CMU 230 operating in response to the first control signal CTR1 may increase the second frequency of the second clock signal CLK2 applied to the memory interface 220. The PMIC 300 operating in response to the third control signal CTR3 may increase the level of the fourth operating voltage PW4 applied to the memory interface 220. In other words, DVFS of the memory interface 220 may be performed in operation S60.

When the slave is the I/O interface 250, the WAP 216 may detect whether the workloads of the CPU 210 are compute-bound or I/O-bound based on the at least one of the first count value NOI and the second count value NOCM in operation S20. When it is detected that the workloads of the CPU 210 are compute-bound (in cases of YES) in operation S20, DVFS of the CPU 210 may be performed in operation S30. However, when it is detected that the workloads of the CPU 210 are not compute-bound (in cases of NO) in operation S20, the WAP 216 may detect if the workloads of the CPU 210 are I/O-bound in operation S40.

When it is detected that the workloads of the CPU 210 are I/O-bound (in cases of YES) in operation S40, the WAP 216 may generate a first intermediate control signal and a second intermediate control signal so that DVFS of the I/O interface 250 is performed. In other words, even if the workloads of the CPU 210 are large, the WAP 216 may generate the first and second intermediate control signals so that the DVFS of the I/O interface 250, instead of the CPU 210, is performed.

The CMU 230 operating in response to the first control signal CTR1 may increase the third frequency of the third clock signal CLK3 applied to the I/O interface 250. The PMIC 300 operating in response to the third control signal CTR3 may increase the level of the sixth operating voltage PW6 applied to the I/O interface 250. In other words, DVFS of the I/O interface 250 may be performed in operation S50.

When it is detected that the workloads of the CPU 210 are neither compute-bound nor I/O-bound (e.g., in cases of NO in both operations S20 and S40), the WAP 216 may generate a first intermediate control signal and a second intermediate control signal, so that DVFS of the CPU 210 and DVFS of the I/O interface 250 are performed simultaneously or in parallel.

The CMU 230 operating in response to the first control signal CTR1 may increase the first frequency of the first clock signal CLK1 applied to the CPU 210. The PMIC 300 operating in response to the third control signal CTR3 may increase the level of the first operating voltage PW1 applied to the CPU 210. In other words, DVFS of the CPU 210 may be performed in operation S60. Simultaneously or in parallel, the CMU 230 operating in response to the first control signal CTR1 may increase the third frequency of the third clock signal CLK3 applied to the I/O interface 250. The PMIC 300 operating in response to the third control signal CTR3 may increase the level of the sixth operating voltage PW6 applied to the I/O interface 250. In other words, DVFS of the I/O interface 250 may be performed in operation S60.

As shown in FIG. 4, the WAP 216 may calculate a CPI value or an MPKI value using at least one of the first count value NOI and the second count value NOCM. When the CPI value or the MPKI value is less than a first reference value REF1, the WAP 216 may detect the workloads of the CPU 210 as compute-bound, and may generate the first control signal CTR1 and the second control signal CTR2 for controlling the DVFS of the CPU 210. When the CPI value or the MPKI value is equal to or greater than the first reference value REF1 and is less than a second reference value REF2, the WAP 216 may generate the first control signal CTR1 and the second control signal CTR2 for controlling the DVFS of the CPU 210 and the DVFS of the slave (e.g., memory interface 220 or I/O interface 250) simultaneously or in parallel. When the CPI value or the MPKI value is equal to or greater than the second reference value REF2, the WAP 216 may detect the workloads of the CPU 210 as memory-bound or I/O-bound, and may generate the first control signal CTR1 and the second control signal CTR2 for controlling the DVFS of the slave (e.g., memory interface 220 or I/O interface 250). The first reference value REF1 and the second reference value REF2 may be programmed by the CPU 210 according to design specifications.

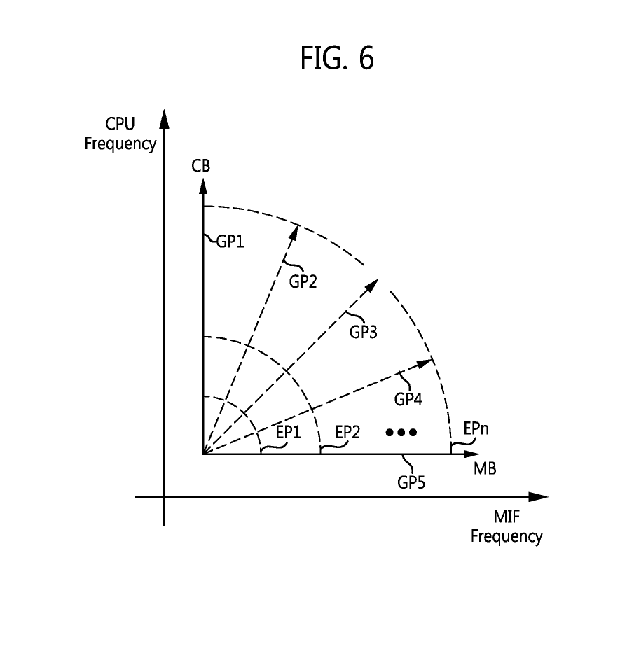

FIG. 6 is a conceptual diagram of a scheme of controlling DVFS of a master and DVFS of a slave. When the workloads of the CPU 210 are compute-bound (CB), the first frequency of the first clock signal CLK1 applied to the CPU 210 (e.g., CPU frequency) may be increased along a first line GP1 and the level of the first operating voltage PW1 applied to the CPU 210 may also be increased along the first line GP1. Each of curves EP1 through EPn may refer to an equivalent voltage line.

When the workloads of the CPU 210 are memory-bound (MB), the second frequency of the second clock signal CLK2 applied to the memory interface 220 (memory interface frequency (“MIF”)) may be increased along a fifth line GP5 and the level of the fourth operating voltage PW4 applied to the memory interface 220 may also be increased along the fifth line GP5.

When the DVFS of the CPU 210 and the DVFS of the slave (e.g., memory interface 220 or I/O interface 250) are performed simultaneously or in parallel according to the workloads of the CPU 210, the first frequency of the first clock signal CLK1 and the level of the first operating voltage PW1, which are applied to the CPU 210, and the frequency of the second clock signal CLK2 or the third clock signal CLK3 and the level of the fourth operating voltage PW4 or the sixth operating voltage PW6, which are applied to the slave (e.g., memory interface 220 or I/O interface 250), may be increased along one of second through fourth lines GP2 through GP4.

The lines GP1 through GP5 and the equivalent voltage lines EP1 through EPn are just examples. The inventive concepts are not restricted to the number and shape of the lines GP1 through GP5, the number of the equivalent voltage lines EP1 through EPn, or gaps among the equivalent voltage lines EP1 through EPn.

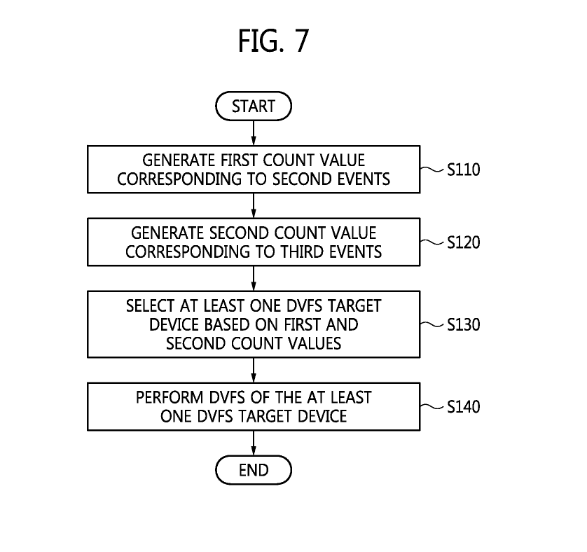

FIG. 7 is a flowchart of a method of operating a SoC according to some example embodiments of the inventive concepts. Referring to FIGS. 1 through 7, the performance monitoring unit 211 may count the number of second events (e.g., the total number of executed instructions) among first events generated while all instructions (or all workloads) are being processed by the master (e.g., CPU 210) during a given time and may generate the first count value NOI in operation S110. The performance monitoring unit 211 may count the number of third events (e.g., the number of L2 cache misses) related with instructions (or workloads) that can be processed by the interaction between the master (e.g., CPU 210) and the slave (e.g., memory interface 220 or I/O interface 250) among the first events and may generate the second count value NOCM in operation S120.

The DVFS program 213 and, more particularly, the WAP 216 may select one or more target devices of DVFS based on the first count value NOI and the second count value NOCM in operation S130. A method of selecting one or more DVFS target devices is the same as or similar to the method described above with reference to FIG. 4 or 5.

The WAP 216 may generate the first control signal CTR1 and the second control signal CTR2 for controlling DVFS of at least one target device. The CMU 230 may adjust (e.g., increase or decrease) the frequency of at least one of the first clock signal CLK1, the second clock signal CLK2, and the third clock signal CLK3 in response to the first control signal CTR1. The PMIC 300 may adjust (e.g., increase or decrease) the level of at least one of the first operating voltage PW1, the fourth operating voltage PW4, and the sixth operating voltage PW6 in response to the third control signal CTRL3. In other words, the controller 200 may perform DVFS of at least one target device using an MPKI value decided based the first count value NOI and the second count value NOCM in operation S140.

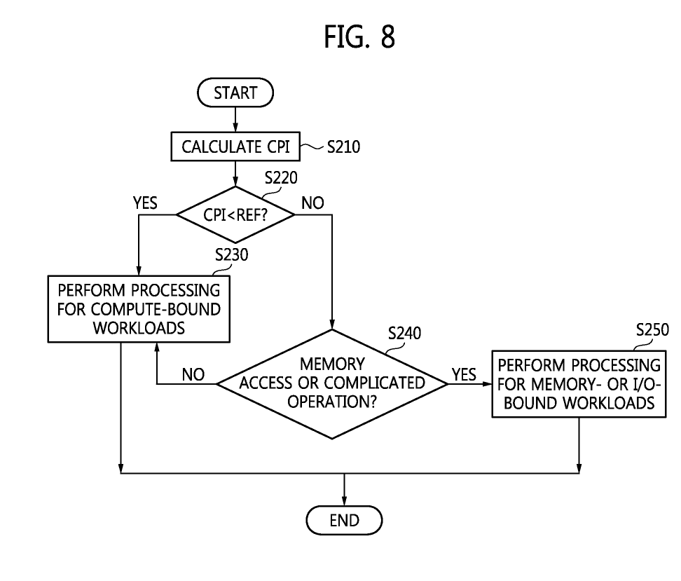

FIG. 8 is a flowchart of a method of operating a SoC according to some example embodiments of the inventive concepts. Referring to FIGS. 1 through 6 and FIG. 8, the performance monitoring unit 211 may calculate a CPI value based on the total number of instructions (or workloads) processed by the CPU 210 during a given time, and may output the CPI value as the first count value NOI in operation S210. The CPI value may not be a count value in the true sense of the word, but it is referred to as the first count value NOI for the coherence with the first count value NOI described with reference to FIGS. 1 through 7.

In cases of a compute-bound program, there are not many events related with instructions (or workloads) for accessing the memory 400. These events may be mostly related with L1 cache hits or L2 cache hits. At this time, memory latency may nearly be 0 cycles and, therefore, the CPI value may be less than 1 or close to 1.

The WAP 216 may compare the CPI value with a reference value REF and detect whether the workloads of the CPU 210 are compute-bound or memory-bound in operation S220. When the CPI value is less than the reference value REF (e.g., 1) (in cases of YES) in operation S220, the WAP 216 may detect that the workloads of the CPU 210 are compute-bound and may generate the first control signal CTR1 and the second control signal CTR2 for controlling DVFS of the CPU 210 according to the detection result in operation S230. However, when an operation performed in the CPU 210 is complicated or involves a floating point, the CPI value may be greater than the reference value REF (e.g., 1) (that is, it may be NO) in operation S220 even when there is no access to the memory 400.

The performance monitoring unit 211 may count the number of third events related with instructions (or workloads) that can be processed by the interaction between the master (e.g., CPU 210) and the slave (e.g., memory interface 220 or I/O interface 250) among first events related with all of the instructions (or workloads) processed by the CPU 210 during the given time, may generate the second count value NOCM, and may provide the second count value NOCM for the WAP 216. As described above, the second count value NOCM may be an L2 cache miss count.

The WAP 216 may detect whether the workloads of the CPU 210 are compute-bound or memory-bound based on the second count value NOCM. For instance, the WAP 216 may detect whether the CPI value has actually increased because of events related with instructions for accessing the memory 400 or because of a complicated operation based on the second count value NOCM in operation S240.

When the CPI value is greater than the reference value REF because of events related with instructions for accessing the memory 400, the WAP 216 may detect the workloads of the CPU 210 as memory-bound, and may generate the first control signal CTR1 and the second control signal CTR2 for controlling DVFS of the slave (e.g., memory interface 220 or I/O interface 250) according to the detection result in operation S250.

However, when the CPI value is greater than the reference value REF because of a complicated operation, the WAP 216 may detect the workloads of the CPU 210 as compute-bound, and may generate the first control signal CTR1 and the second control signal CTR2 for controlling DVFS of the CPU 210 according to the detection result in operation S230. In other words, when the second count value NOCM is less than a reference value REF, operation S230 may be performed. When the second count value NOCM is equal to or greater than the reference value REF, operation S250 may be performed. The CPI value may be influenced by the second count value NOCM.

As described above, according to some example embodiments of the inventive concepts, a SoC controls DVFS of a master and DVFS of a slave communicating with the master according to types of workloads of the master, thereby increasing the performance.

Algorithms for implementation or control of the technologies discussed in this application (e.g., for SoCs, for DVFS, for controlling power using workloads, for methods of operation, and for associated computing devices) may be used for implementation or control of more general purpose apparatuses and/or methods of controlling apparatuses.

Methods for implementation or control of the technologies discussed in this application may be written as computer programs and can be implemented in general-use digital computers that execute the programs using a computer-readable recording medium. In addition, a structure of data used in the methods may be recorded in a computer-readable recording medium in various ways. Examples of the computer-readable recording medium include storage media such as magnetic storage media (e.g., ROM (Read-Only Memory), RAM (Random-Access Memory), USB (Universal Serial Bus), floppy disks, hard disks, etc.) and optical recording media (e.g., CD-ROMs (Compact Disc Read-Only Memories) or DVDs (Digital Video Discs)).

In addition, some example embodiments may also be implemented through computer-readable code/instructions in/on a medium (e.g., a computer-readable medium) to control at least one processing element to implement some example embodiments. The medium may correspond to any medium/media permitting the storage and/or transmission of the computer-readable code.

The computer-readable code may be recorded/transferred on a medium in a variety of ways, with examples of the medium including recording media, such as magnetic storage media (e.g., ROM, floppy disks, hard disks, etc.) and optical recording media (e.g., CD-ROMs or DVDs), and transmission media such as Internet transmission media. Thus, the medium may be such a defined and measurable structure including or carrying a signal or information, such as a device carrying a bitstream according to some example embodiments. The media may also be a distributed network, so that the computer-readable code is stored/transferred and executed in a distributed fashion. Furthermore, the processing element could include a processor or a computer processor, and processing elements may be distributed and/or included in a single device.

In some example embodiments, some of the elements may be implemented as a ‘module’. According to some example embodiments, ‘module’ may be interpreted as software-based components or hardware components, such as a field programmable gate array (FPGA) or an application specific integrated circuit (ASIC), and the module may perform certain functions. However, the module is not limited to software or hardware. The module may be configured so as to be placed in a storage medium which may perform addressing, or to execute one or more processes.

For example, modules may include components such as software components, object-oriented software components, class components, and task components, processes, functions, attributes, procedures, subroutines, segments of program code, drivers, firmware, microcodes, circuits, data, databases, data structures, tables, arrays, and variables. Functions provided from the components and the modules may be combined into a smaller number of components and modules, or be separated into additional components and modules. Moreover, the components and the modules may execute one or more central processing units (CPUs) in a device.

Some example embodiments may be implemented through a medium including computer-readable codes/instructions to control at least one processing element of the above-described embodiments, for example, a computer-readable medium. Such a medium may correspond to a medium/media that may store and/or transmit the computer-readable codes.

The computer-readable codes may be recorded in a medium or be transmitted over the Internet. For example, the medium may include a ROM, a RAM, a CD-ROM, a magnetic tape, a floppy disc, an optical recording medium, or a carrier wave such as data transmission over the Internet. Further, the medium may be a non-transitory computer-readable medium. Since the medium may be a distributed network, the computer-readable code may be stored, transmitted, and executed in a distributed manner. Further, for example, the processing element may include a processor or a computer processor, and be distributed and/or included in one device.

While some example embodiments of the inventive concepts have been particularly shown and described with reference to some example embodiments thereof, it will be understood by those of ordinary skill in the art that various changes in forms and details may be made therein without departing from the spirit and scope of the inventive concepts as defined by the following claims.

It should be understood that example embodiments described herein should be considered in a descriptive sense only and not for purposes of limitation. Descriptions of features or aspects within example embodiments should typically be considered as available for other similar features or aspects in other example embodiments.

1. A system on chip, comprising:
a master device configured to execute a dynamic voltage and frequency scaling (DVFS) program;
a slave device configured to communicate with the master device; and
a performance monitoring unit configured to receive first events generated while instructions are being processed by the master device, configured to generate a first count value by counting a number of second events corresponding to a total number of the instructions related with the first events, and configured to generate a second count value by counting a number of third events related with first instructions that can be processed by interaction between the master device and the slave device among the first events,
wherein the DVFS program is configured to generate a control signal for controlling DVFS of at least one of the master device and the slave device based on the first count value and the second count value.

2. The system on chip of claim 1, wherein the master device is one of a central processing unit (CPU), a graphics processing unit (GPU), an image signal processor (ISP), a digital signal processor (DSP), and a multimedia processor, and
wherein the slave device is one of a memory interface and an input/output interface.

3. The system on chip of claim 1, further comprising:
a clock management unit configured to control at least one of a first frequency of a first clock signal applied to the master device and a second frequency of a second clock signal applied to the slave device in response to the control signal.

4. The system on chip of claim 1, further comprising:
a power management unit configured to control a power management integrated circuit to control at least one of a level of a first voltage applied to the master device and a level of a second voltage applied to the slave device in response to the control signal.

5. The system on chip of claim 1, wherein the second events are related with instructions executed by the master device and the third events are related with L2 cache misses.

6. The system on chip of claim 1, wherein the DVFS program is configured to calculate a misses-per-kilo-instructions (MPKI) value based on the first count value and the second count value, and is configured to generate the control signal based on the MPKI value, and
wherein the second count value is an L2 cache miss count.

7. A computing device, comprising:
a master device configured to execute a dynamic voltage and frequency scaling (DVFS) program;
a slave device configured to communicate with the master device;
a performance monitoring unit configured to receive first events generated while instructions are being processed by the master device, configured to generate a first count value by counting a number of second events corresponding to a total number of the instructions related with the first events, and configured to generate a second count value by counting a number of third events related with first instructions that can be processed by interaction between the master device and the slave device among the first events; and
a power management integrated circuit (PMIC) configured to provide a corresponding operating voltage to the master device, the slave device, and the performance monitoring unit;
wherein the DVFS program is configured to generate a control signal for controlling DVFS of at least one of the master device and the slave device based on the first count value and the second count value.

8. The computing device of claim 7, wherein the master device is one of a central processing unit (CPU), a graphics processing unit (GPU), an image signal processor (ISP), a digital signal processor (DSP), and a multimedia processor, and
wherein the slave device is one of a memory interface and an input/output interface.

9. The computing device of claim 7, further comprising:
a clock management unit configured to control at least one of a first frequency of a first clock signal applied to the master device and a second frequency of a second clock signal applied to the slave device in response to the control signal.

10. The computing device of claim 7, further comprising:
a power management unit configured to control the PMIC to control at least one of a level of a first voltage applied to the master device and a level of a second voltage applied to the slave device in response to the control signal.

11. The computing device of claim 7, wherein the second events are related with instructions executed by the master device and the third events are related with L2 cache misses.

12. The computing device of claim 7, wherein the DVFS program is configured to calculate a misses-per-kilo-instructions (MPKI) value based on the first count value and the second count value, and is configured to generate the control signal based on the MPKI value, and
wherein the second count value results from counting L2 cache misses.

13. The computing device of claim 7, further comprising:
a memory;
wherein the master device is one of a central processing unit (CPU), a graphics processing unit (GPU), an image signal processor (ISP), a digital signal processor (DSP), and a multimedia processor, and
wherein the slave device is a memory interface is configured to control operation of the memory according to control of the master device.

14.-20. (canceled)

21. A computing device, comprising:
a first device configured to execute a program;
a second device configured to communicate with the first device;
a third device configured to receive first events generated while instructions are being processed by the first device, configured to generate a first count value by counting a number of second events corresponding to a total number of the instructions related with the first events, and configured to generate a second count value by counting a number of third events related first instructions that can be processed by interaction between the first device and the second device among the first events; and
a fourth device configured to provide an operating voltage to the first device or the second device;
wherein the program is configured to generate a control signal for controlling the first device, the slave, or the first device and the second device based on the first and second count values.

22. The computing device of claim 21, wherein the program comprises a dynamic voltage and frequency scaling (DVFS) program.

23. The computing device of claim 21, wherein the program is configured to control providing operating voltages to the first device and the second device.

24. The computing device of claim 21, wherein the first device comprises a central processing unit (CPU), a graphics processing unit (GPU), an image signal processor (ISP), a digital signal processor (DSP), or a multimedia processor.

25. The computing device of claim 21, wherein the second device comprises a memory interface or an input/output interface.

26. The computing device of claim 21, further comprising:
a fifth device configured to control a frequency provided to the first device or the second device.

27. The computing device of claim 21, further comprising:
a fifth device configured to control a level of the operating voltage provided to the first device or the second device.
